(19) United States
(12) Patent Application Publication
(10) Pub. No.: US 2023/0162480 A1
(43) Pub. Date: May 25, 2023

(54) FREQUENCY-BASED FEATURE CONSTRAINT FOR A NEURAL NETWORK

(71) Applicant: GM Global Technology Operations LLC, Detroit, MI (US)

(72) Inventors: Jordan B. Chipka, Commerce Township, MI (US); Wei Tong, Troy, MI (US)

(21) Appl. No.: 17/535,122

(22) Filed: Nov. 24, 2021

(51) Int. Cl. G06V 10/774; G06V 10/776; G06V 10/82; G06V 10/77; G06V 10/88; G06N 3/04; G06N 3/08

(52) U.S. Cl. CPC G06V 10/774; G06N 3/04; G06N 3/08; G06V 10/82; G06V 10/89; G06V 10/776; G06V 10/7715

(57) ABSTRACT

A system comprises a computer including a processor and a memory. The memory includes instructions such that the processor is programmed to: receive, at a neural network, frequency filtered spatial domain data, compare an output generated by the neural network to a loss function including a frequency-based feature consistency constraint, and update at least one weight of the neural network according to the loss function.

### INTRODUCTION

The present disclosure relates to training a neural network with a loss function that includes a frequency-based feature consistency constraint.

Deep neural networks (DNNs) can be used to perform many image understanding tasks, including classification, segmentation, and captioning. Typically, DNNs require large amounts of training images (tens of thousands to millions). Additionally, these training images typically need to be annotated, e.g., labeled, for the purposes of training and prediction.

### SUMMARY

A system comprises a computer including a processor and a memory. The memory includes instructions such that the processor is programmed to: receive, at a neural network, frequency filtered spatial domain data, compare an output generated by the neural network to a loss function including a frequency-based feature consistency constraint, and update at least one weight of the neural network according to the loss function.

In other features, the processor is further programmed to transform data from a spatial domain to a frequency domain using a Fourier transform process.

In other features, the processor is further programmed to filter features from the transformed data based on a predetermined frequency.

In other features, the processor is further programmed to transform the filtered transformed data from the frequency domain to the spatial domain to generate the frequency filtered spatial domain data.

In other features, the processor is further programmed to filter the features based on at least one of a high-pass frequency or a low-pass frequency.

In other features, the Fourier transform process comprises a Fast Fourier transform process.

In other features, the output generated by the neural network comprises a latent representation of the frequency filtered spatial domain data.

In other features, the neural network comprises a convolutional neural network.

In other features, the frequency filtered spatial domain data corresponds to an image captured within a field-of-view of a vehicle camera.

In other features, the image comprises a Red-Green-Blue image.

A method includes receiving, at a first neural network, receiving, at a neural network, frequency filtered spatial domain data, comparing an output generated by the neural network to a loss function including a frequency-based feature consistency constraint, and updating at least one weight of the neural network according to the loss function.

In other features, the method includes transforming data from a spatial domain to a frequency domain using a Fourier transform process.

In other features, the method includes filtering features from the transformed data based on a predetermined frequency.

In other features, the method includes transforming the filtered transformed data from the frequency domain to the spatial domain to generate the frequency filtered spatial domain data.

In other features, the method includes filtering the features based on at least one of a high-pass frequency or a low-pass frequency.

In other features, the Fourier transform process comprises a Fast Fourier transform process.

In other features, the output generated by the neural network comprises a latent representation of the frequency filtered spatial domain data.

In other features, the neural network comprises a convolutional neural network.

In other features, the frequency filtered spatial domain data corresponds to an image captured within a field-of-view of a vehicle camera.

In other features, the image comprises a Red-Green-Blue image.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of an example system including a vehicle;

FIG. 2 is a block diagram of an example server within the system;

FIG. 3 is a diagram of an example neural network;

FIG. 4 is a block diagram of an example frequency feature extraction system;

FIG. 5 is a block diagram of an example convolutional neural network;

FIGS. 6A through 6C is a block diagram illustrating an example process for training a neural network;

FIG. 7 is a block diagram of an example domain adaptation network;

FIG. 8 is a flow diagram illustrating an example process for controlling a vehicle; and

FIG. 9 is a flow diagram illustrating an example process for training a neural network.

### DETAILED DESCRIPTION

The following description is merely exemplary in nature and is not intended to limit the present disclosure, application, or uses.

Typically, standard deep neural networks (DNNs) are pre-trained with labeled training datasets. These DNNs can be validated during testing by comparing the output of the model to ground truth. However, obtaining ground truth data can be difficult in real-world testing scenarios.

Domain adaptation is directed to generalizing a model from source domain to a target domain. Typically, the source domain has a large amount of training data while data in the target domain can be scarce. For instance, the availability of back-up camera lane data can be constrained due to camera-supplier constraints, rewiring problems, lack of relevant applications, and the like. However, there may be a number of datasets that include forward looking camera images that include lanes.

The present disclosure discloses systems and methods that train a neural network using a loss function that includes a frequency-based feature consistency constraint. The trained neural network can receive data in a source domain and generate data in a target domain. For example, the trained neural network can receive images including one or more features captured in daylight and generate images including the features such that the image appears to have been captured at night.

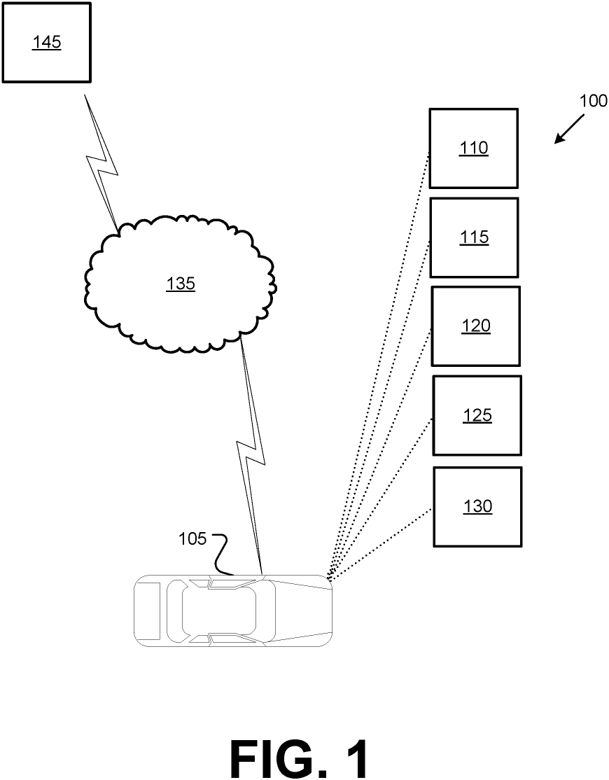

FIG. 1 is a block diagram of an example vehicle system 100. The system 100 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 includes a processor and a memory. The memory includes one or more forms of computer readable media, and stores instructions executable by the computer 110 for performing various operations, including as disclosed herein.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110. The vehicle 105 communications network can include one or more gateway modules that provide interoperability between various networks and devices within the vehicle 105, such as protocol translators, impedance matchers, rate converters, and the like.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g., front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation-such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle to vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short-range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

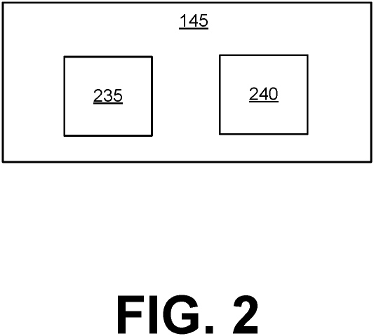

FIG. 2 is a block diagram of an example server 145. The server 145 includes a computer 235 and a communications module 240. The computer 235 includes a processor and a memory. The memory includes one or more forms of computer readable media, and stores instructions executable by the computer 235 for performing various operations, including as disclosed herein. The communications module 240 allows the computer 235 to communicate with other devices, such as the vehicle 105.

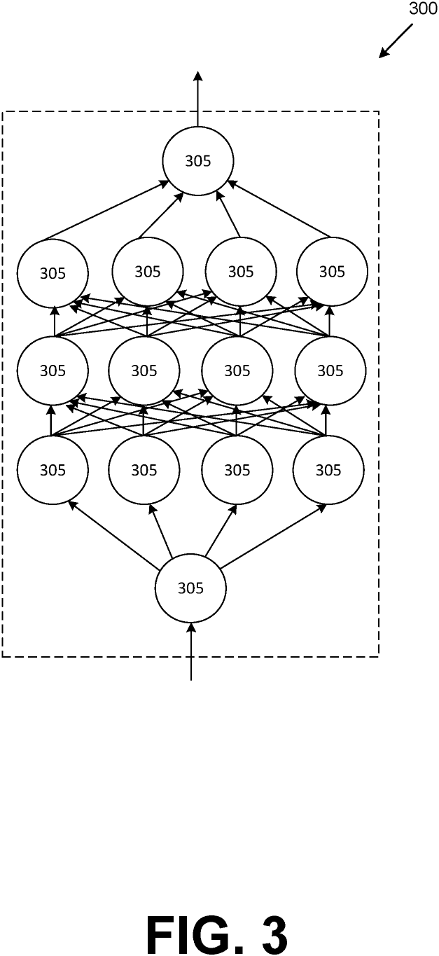

FIG. 3 is a diagram of an example deep neural network (DNN) 300 that may be used herein. The DNN 300 includes multiple nodes 305, and the nodes 305 are arranged so that the DNN 300 includes an input layer, one or more hidden layers, and an output layer. Each layer of the DNN 300 can include a plurality of nodes 305. While FIG. 3 illustrates three (3) hidden layers, it is understood that the DNN 300 can include additional or fewer hidden layers. The input and output layers may also include more than one (1) node 305.

The nodes 305 are sometimes referred to as artificial neurons 305, because they are designed to emulate biological, e.g., human, neurons. A set of inputs (represented by the arrows) to each neuron 305 are each multiplied by respective weights. The weighted inputs can then be summed in an input function to provide, possibly adjusted by a bias, a net input. The net input can then be provided to activation function, which in turn provides a connected neuron 305 an output. The activation function can be a variety of suitable functions, typically selected based on empirical analysis. As illustrated by the arrows in FIG. 3, neuron 305 outputs can then be provided for inclusion in a set of inputs to one or more neurons 305 in a next layer.

The DNN 300 can be trained to accept data as input and generate an output based on the input. In one example, the DNN 300 can be trained with ground truth data, i.e., data about a real-world condition or state. For instance, the DNN 300 can be trained with ground truth data or updated with additional data by a processor. Weights can be initialized by using a Gaussian distribution, for example, and a bias for each node 305 can be set to zero. Training the DNN 300 can including updating weights and biases via suitable techniques such as backpropagation with optimizations. Ground truth data can include, but is not limited to, data specifying objects within an image or data specifying a physical parameter, e.g., angle, speed, distance, color, hue, or angle of object relative to another object. For example, the ground truth data may be data representing objects and object labels.

Machine learning services, such as those based on Recurrent Neural Networks (RNNs), Convolutional Neural Networks (CNNs), Long Short-Term Memory (LSTM) neural networks, or Gated Recurrent Unit (GRUs) may be implemented using the DNNs 300 described in this disclosure. In one example, the service-related content or other information, such as words, sentences, images, videos, or other such content/information may be translated into a vector representation.

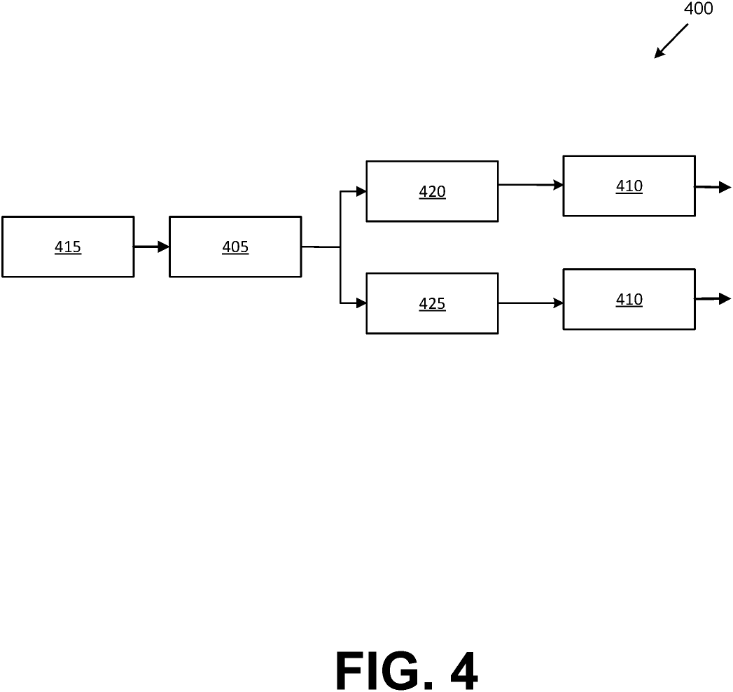

FIG. 4 is a diagram of an example frequency feature extraction system 400. The frequency feature extraction system 400 can be a software program that can be loaded in memory and executed by a processor in the vehicle 105 and/or the server 145, for example. As shown, the frequency feature extraction system 400 can include a transform module 405 and an inverse transform module 410. In various implementations, the transform module 405 and the inverse transform module 410 perform suitable Fourier transform processes, such as Fast Fourier transform processes, on the received data. For example, the transform module 405 converts input data 415 from the spatial domain to the frequency domain. The input data 415 can comprise image data, audio data, or the like.

The transform module 405 provides the transformed data, i.e., data represented in the frequency domain, to a high-pass filter 420 and to a low-pass filter 425. The high-pass filter 420 passes data having a frequency higher than a predetermined high-pass cutoff frequency, and the low-pass filter 425 passes data having a frequency lower than a predetermined low-pass cutoff frequency. The high-pass filter 420 provides the filtered data to the inverse transform module 410 that converts the filtered data from the frequency domain to the spatial domain, and the low-pass filter 425 provides the filtered data to the inverse transform module 410 that converts the filtered data from the frequency domain to the spatial domain. For instance, the inverse transform module 410 can generate an altered image based on the respective filtering from the high-pass filter 420 or the low-pass filter 425.

As described in greater detail below, the filtered spatial domain data, such as the altered images, can be provided to a DNN 300 to apply feature constraints to input data based on the frequency feature. For example, the DNN 300 can be trained using a loss function including a frequency-based feature consistency constraint to allow the DNN 300 to learn domain independent features. As such, labeled features can be maintained in an image within the source domain.

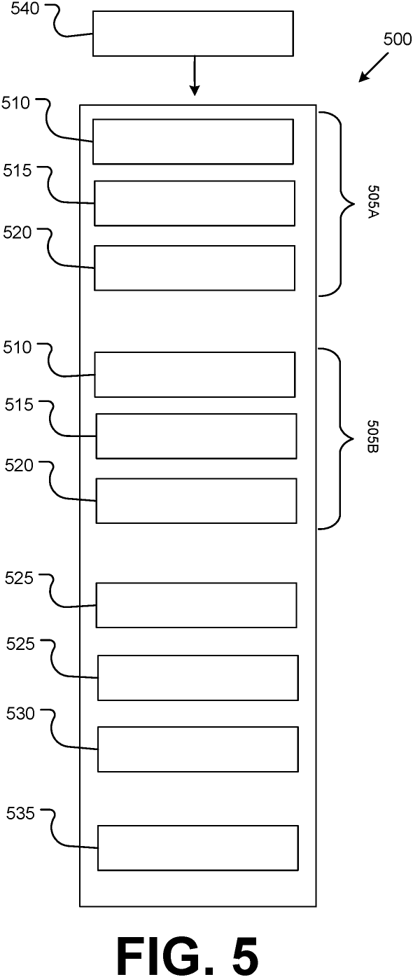

FIG. 5 is a block diagram illustrating an example DNN 300. In the implementation illustrated in FIG. 5, the DNN 300 is a convolutional neural network 500. The convolutional neural network 500 may include multiple different types of layers based on connectivity and weight sharing. As shown, the convolutional neural network 500 includes convolution blocks 505A, 505B. Each of the convolution blocks 505A, 505B may be configured with a convolution layer (CONV) 510, a normalization layer (LNorm) 515, and a max pooling layer (MAX POOL) 520.

The convolution layers 510 may include one or more convolutional filters, which are be applied to the input data 545 to generate an output 540. While FIG. 5 illustrates only two convolution blocks 505A, 505B, the present disclosure may include any number of the convolution blocks 505A, 505B. The normalization layer 515 may normalize the output of the convolution filters. For example, the normalization layer 515 may provide whitening or lateral inhibition. The max pooling layer 520 may provide down sampling aggregation over space for local invariance and dimensionality reduction.

The deep convolutional network 500 may also include one or more fully connected layers 525 (FC1 and FC2). The deep convolutional network 500 may further include a logistic regression (LR) layer 530. Between each layer 510, 515, 520, 525, 530 of the deep convolutional network 500 are weights that can be updated. The output of each of the layers (e.g., 510, 515, 520, 525, 530) may serve as an input of a succeeding one of the layers (e.g., 510, 515, 520, 525, 530) in the convolutional neural network 500 to learn features from input data 540, e.g., images, audio, video, sensor data and/or other input data provided at the first of the convolution blocks 505A. The output 535 can represent a latent representation of one or more features based on the input data. For example, the output 535 can comprise latent features of an input image within a first domain sourced from a real data distribution, such as a Red-Green-Blue (RGB) image captured during daylight. The output 535 can be converted, via a decoder, to a synthetic image within a second domain, such as a synthetic RGB image that illustrates features from the input image during night.

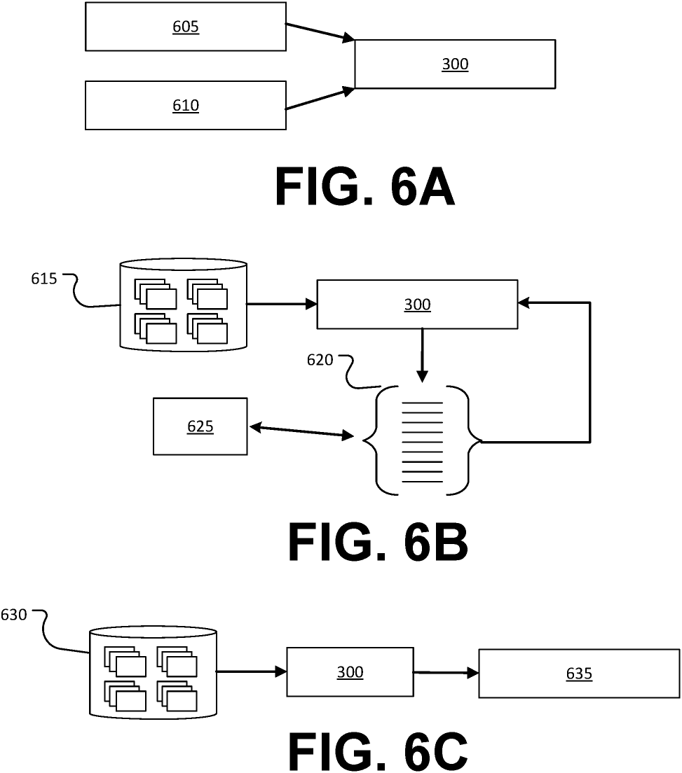

FIGS. 6A and 6B illustrate an example process for training the DNN 300 in accordance with one or more implementations of the present disclosure. As shown in FIG. 6A, during an initial training phase, a DNN 300 receives a set of labeled training data 605 and training labels 610. The training data 605 can comprise transformed frequency filtered spatial domain data in accordance with the process described above in reference to FIG. 4. For example, the filtered spatial domain data can comprise one or more images depicting objects within a field-of-view (FOV) of a vehicle camera. The training labels 610 may comprise object labels, object type labels, domain type, and/or distance of the object with respect to the source of the image.

After the initial training phase, at a supervised training phase, a set of N training data 615 is input to the DNN 300. The DNN 300 generates outputs translated data for each of the N training data 615 inputs. For example, the DNN 300 can generate a synthetic image that includes the features within the training data in the second domain. FIG. 6B illustrates an example of generating output based on training data 615, e.g., non-labeled training images, of the N training data 615. Based on the initial training, the DNN 300 outputs a vector representation 620 of the output data, e.g., latent representations of the training data. The vector representation 620 is compared to ground-truth data 625. The ground-truth data 625 can include a frequency-based feature consistency constraint. For example, the frequency-based feature consistency constraint may comprise a portion of a loss function such that features within the data corresponding to low frequency are consistent across the domains and features within the data corresponding to high frequency are mitigated or reduced across the domains.

The DNN 300 updates network parameters based on the comparison to the ground-truth data 625. For example, the network parameters, e.g., weights associated with the neurons, may be updated via backpropagation. The DNN 300 may be trained at the server 145 and provided to the vehicle 105 via the communication network 135. The vehicle 105 may also provide data captured by the vehicle 105 systems to the server 145 for further training purposes.

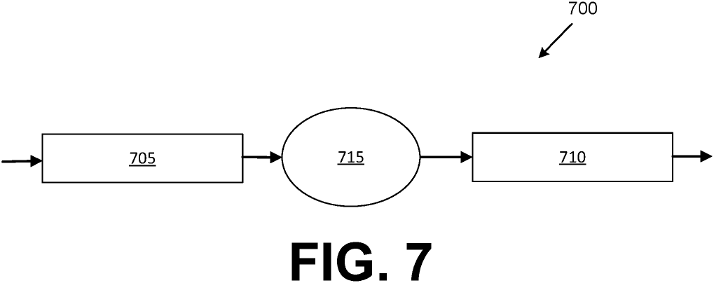

FIG. 7 is a diagram of an example domain adaptation network 700 that can convert data within the source domain to the source domain to data within the target domain. The domain adaptation network 700 can be a software program that can be loaded in memory and executed by a processor in the vehicle 105 and/or the server 145, for example. In an example implementation, the domain adaptation network 700 can receive a sequence of images in the source domain, e.g., daytime, and output a sequence of images in the target domain, e.g., nighttime.

As shown, the domain adaptation network 700 comprises an autoencoder that includes an encoder 705 and a decoder 710. In an example implementation, the encoder 705 can comprise the trained DNN 300 as described above with respect to FIGS. 6A and 6B. In various implementations, the decoder 710 is symmetrical to the encoder 705. The encoder 705 receives input data from the source domain and generates a latent representation 715 of the input data, and the decoder 710 reconstructs output data in the source domain based on the latent representation 715 of the input data in the target domain.

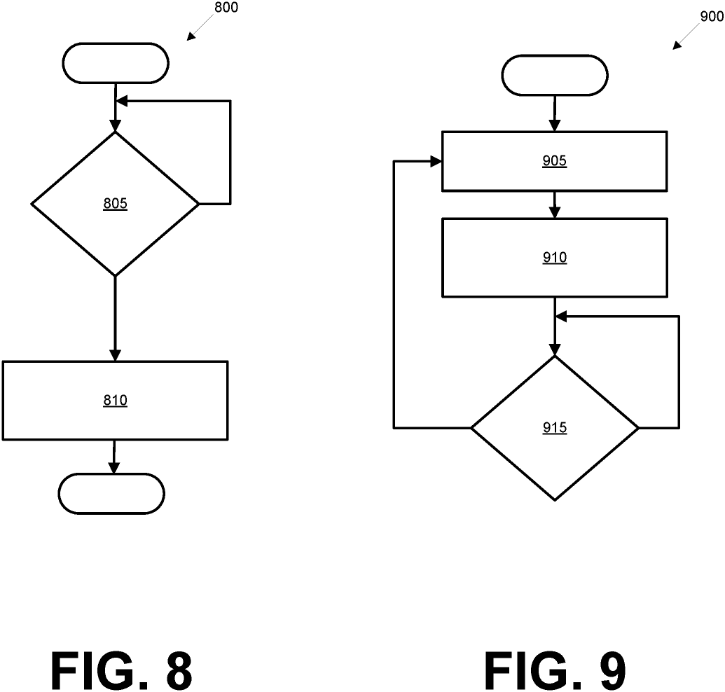

FIG. 8 is a flowchart of an example process 800 for controlling the vehicle 105 based on the determined output of a neural network trained according to the processes described herein. Blocks of the process 800 can be executed by the computer 110. The process 800 begins at block 805, in which the computer 110 determines whether to actuate the vehicle 105 based on the determined output. The computer 110 can include a lookup table that establishes a relationship between a determined output and a vehicle actuation action. For example, based on an image captured by one or more sensors 115 of the vehicle 105, the computer 110 may cause the vehicle 105 to perform a specified action, e.g., initiate a vehicle 105 turn, adjust vehicle 105 direction, adjust vehicle 105 speed, etc. In another example, based on the determined distance between the vehicle 105 and an object, the computer 110 may cause the vehicle 105 to perform a specified action, e.g., initiate a vehicle 105 turn, initiate an external alert, adjust vehicle 105 speed, etc.

If the computer determines that no actuation is to occur, the process 800 returns to block 805. Otherwise, at block 810, the computer 110 causes the vehicle 105 to actuate according to the specified action. For example, the computer 110 transmits the appropriate control signals to the corresponding actuators 120.

FIG. 9 is a flowchart of an example process 900 for training the DNN 300. Blocks of the process 900 can be executed by the computer 235. The process 900 begins in a block 905, in which the computer 235 trains the DNN 300. For example, the DNN 300 may be trained with transformed filtered spatial domain data as described in greater detail above.

At block 910, the computer 235 transmits the trained DNN 300 to the vehicle 105. The computer 235 determines whether additional data has been received at block 815. For example, the data may be sensor data that the computer 110 has uploaded. If no additional sensor data has been uploaded, the process 900 returns to block 915. If additional sensor data has been uploaded, the process 900 returns to block 905 so that the DNN 300 can be trained with transformed filtered spatial domain data based on the uploaded sensor data.

The description of the present disclosure is merely exemplary in nature and variations that do not depart from the gist of the present disclosure are intended to be within the scope of the present disclosure. Such variations are not to be regarded as a departure from the spirit and scope of the present disclosure.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
receive, at a neural network, frequency filtered spatial domain data;
compare an output generated by the neural network to a loss function including a frequency-based feature consistency constraint; and
update at least one weight of the neural network according to the loss function.

2. The system of claim 1, wherein the processor is further programmed to transform data from a spatial domain to a frequency domain using a Fourier transform process.

3. The system of claim 2, wherein the processor is further programmed to filter features from the transformed data based on a predetermined frequency.

4. The system of claim 3, wherein the processor is further programmed to transform the filtered transformed data from the frequency domain to the spatial domain to generate the frequency filtered spatial domain data.

5. The system of claim 2, wherein the processor is further programmed to filter the features based on at least one of a high-pass frequency or a low-pass frequency.

6. The system of claim 2, wherein the Fourier transform process comprises a Fast Fourier transform process.

7. The system of claim 1, wherein the output generated by the neural network comprises a latent representation of the frequency filtered spatial domain data.

8. The system of claim 1, wherein the neural network comprises a convolutional neural network.

9. The system of claim 1, wherein the frequency filtered spatial domain data corresponds to an image captured within a field-of-view of a vehicle camera.

10. The system of claim 9, wherein the image comprises a Red-Green-Blue image.

11. A method comprising:
receiving, at a neural network, frequency filtered spatial domain data;
comparing an output generated by the neural network to a loss function including a frequency-based feature consistency constraint; and
updating at least one weight of the neural network according to the loss function.

12. The method of claim 11, the method further comprising transforming data from a spatial domain to a frequency domain using a Fourier transform process.

13. The method of claim 12, the method further comprising filtering features from the transformed data based on a predetermined frequency.

14. The method of claim 13, the method further comprising transforming the filtered transformed data from the frequency domain to the spatial domain to generate the frequency filtered spatial domain data.

15. The method of claim 12, the method further comprising filtering the features based on at least one of a high-pass frequency or a low-pass frequency.

16. The method of claim 12, wherein the Fourier transform process comprises a Fast Fourier transform process.

17. The method of claim 11, wherein the output generated by the neural network comprises a latent representation of the frequency filtered spatial domain data.

18. The method of claim 11, wherein the neural network comprises a convolutional neural network.

19. The method of claim 11, wherein the frequency filtered spatial domain data corresponds to an image captured within a field-of-view of a vehicle camera.

20. The method of claim 19, wherein the image comprises a Red-Green-Blue image.
